(19) United States
(12) Patent Application Publication
(10) Pub. No.: US 2020/0166094 A1
(43) Pub. Date: May 28, 2020

(54) FRICTION RING ELEMENT, FRICTION RING SET FOR ARRANGING ON THE WHEEL WEB OF A TRACK WHEEL, AND TRACK WHEEL BRAKE

(71) Applicant: Faiveley Transport Witten GmbH, Witten (DE)

(72) Inventors: Philipp Imhof, Witten (DE); Andreas Mehlan, Witten (DE); Andreas Stroetmann, Witten (DE)

(73) Assignee: Faiveley Transport Witten GmbH, Witten (DE)

(21) Appl. No.: 16/622,551

(22) PCT Filed: Jun. 12, 2018
(86) PCT No.: PCT/EP2018/065475

§ 371 Date: Dec. 13, 2019

(30) Foreign Application Priority Data
Jun. 14, 2017 (DE) 20 2017 103 551.4

(51) Int. Cl. F16D 65/12; B61H 5/00; B60B 17/00

(52) U.S. Cl. CPC F16D 65/124; F16D 65/128; F16D 2065/1384; B60B 17/00; F16D 2200/0021; B61H 5/00

(57) ABSTRACT

In order to provide a development of friction ring elements for a friction ring set for arranging on the wheel web of a track wheel in order to form a track wheel brake, wherein the friction ring elements can be simply and cost-effectively produced and can be easily fitted with linking elements, a friction ring element (10) is proposed for a friction ring set (200) for arranging on the wheel web (2) of a track wheel (1) for a railway vehicle in order to form a track wheel brake (100), wherein the friction ring element (10) has a friction ring (11) and multiple linking elements (12, 13) designed as separate components and arranged on the friction ring (11), and wherein at least some of the linking elements (12, 13) are force-lockingly connected to the friction ring (11).

The present invention relates to a friction ring element for a friction ring set and to such a friction ring set for arranging on the wheel web of a track wheel for a rail vehicle in order to form a track wheel brake and also relates to such a track brake.

### PRIOR ART

EP 1 460 283 A1 shows, for example, a friction ring element arranged on the wheel web of a track wheel for a rail vehicle in order to form a track wheel brake. The friction ring elements are made of cast steel and have mouldings that form cooling fins and with which the friction ring elements abut on the surface of the wheel web. The mouldings also serve to accommodate through-bolts in order to screw the friction ring elements against each other by passing the through bolts through holes in the wheel web. The shown geometry of the friction ring elements can be technically reasonably produced only with a relatively expensive original mould procedure.

Further friction ring elements for arranging on the wheel web of a track wheel are shown in EP 1 298 333 B1 and in DE 44 17 813 A1. The casting production of such friction ring elements requires technically complex casting moulds, in particular, if the friction ring elements have mouldings with which they abut on the wheel web of the track wheel, and if the friction ring elements, for example, must have cooling fins to cool the friction rings.

For this purpose, a solution is known from DE 20 2013 103 487 U1, in which a friction ring element for arranging on the wheel web of a track wheel for a rail vehicle as well as a corresponding track wheel brake are described. Here it is proposed to cut out a friction ring element from a flat metal material and to provide separate linking elements which can be inserted into bores of the friction ring and are then positively jointed to this friction ring. A disadvantage of this embodiment is that the materials for the friction ring and the linking elements must be matched to one another in such a way that a (cost-effective) welding process is applicable.

### DISCLOSURE OF THE INVENTION

The object of the invention thus results in a development of friction ring elements for a friction ring set for arranging on the wheel web of a track wheel in order to form a track wheel brake that can be simply and cost-effectively produced. In particular, the friction ring elements should be able to be equipped with linking elements in a simple manner, wherein the linking elements should form in particular cooling elements and/or connecting elements, via which the friction rings can be linked to the wheel web.

This object is solved based on a friction ring element according to the preamble of claim 1 and based on a friction ring set according to the preamble of claim 14 for arranging on the wheel web of a track wheel for a rail vehicle in order to form a track wheel brake and based on a track wheel brake according to the preamble of claim 20 with the respective characteristic features. Advantageous developments of the invention are specified in the dependent claims.

According to a first embodiment, the separately formed linking elements or at least some of the linking elements are force-lockingly connected to the friction ring. A suitable force-locking connection is, inter alia, a screw connection between the linking element and the friction ring. However, under the mechanical load on a track wheel and in particular on a track wheel brake, an additional safety device is to be provided, for example a caulking. Here it is particularly preferred to press the separately formed linking elements into a corresponding opening having an undersize, or to press the linking elements with the connecting section, for example a shaft, having an oversize into the corresponding opening. Possible embodiments are the driving of the linking element into the opening and/or the thermal press-fitting, wherein preferably the respective linking element is shrunk by means of undercooling.

The friction ring element proposed here comprises a friction ring which can be produced by a two-dimensional production process. In that regard, reference is made to the teaching of DE 20 2013 103 487 U1. The function of the linking elements can be configured in various ways, as well, for example by them forming cooling elements, connecting elements or merely for serving to ensure a set distance between the surface of the wheel web and the friction ring. Also in this regard, reference is made in full to DE 20 2013 103 487 U1. It should be noted that a connecting element at the same time can be configured as a cooling element, but not vice versa. Furthermore, it should be noted that the linking elements as raw components, regardless of their function, can be configured partially or all identical or different.

Here, however, it is proposed to provide the linking elements and the friction ring made of different metallic materials, for example aluminium and steel, or else only different alloys. In this case, the linking elements and the friction ring can be selected from materials which are incompatible with welding technology, so that the degree of freedom in selecting the materials is significantly increased. For the selection of the material of the friction ring, it should be paid attention to good wear characteristics, while the linking elements do not come into frictional contact with a brake pad and are mainly used, for example, only as a spacer between the wheel web and the friction ring. Due to the distance between the friction ring and the wheel web, an air flow is generated with which a sufficient cooling of the friction ring can be ensured. The linking elements can therefore be selected from a more cost-effective material and/or from a material with a thermal expansion coefficient suitable for the application.

In a preferred embodiment, some of the linking elements are formed as connecting elements, wherein these are configured in such a way that the friction ring can expand radially relative to the wheel web due to a heat input of a braking operation and is at the same time fixed in the direction of rotation relative to the wheel web, so that a relative contortion between the wheel web and the friction ring element is prevented solely by means of the connecting elements. Here, the connecting element is arranged in such a way that no radial stress can be induced into the friction ring element. Due to the arrangement of the linking elements, the friction ring can rest on the outer and inner diameter in such a way that no radial stress arises in the friction ring. As a result, a shielding, i.e. a plate spring-like setting up of the friction element due to a thermal entry during braking, is excluded. Also excluded by this arrangement is a faulty mounting of the friction element to the wheel web.

In a preferred embodiment, such a connecting element has two stop walls parallel to each other, in particular plane-parallel stop walls. The stop walls are aligned parallel to the radius starting from the axis of rotation of the track wheel, in the arrangement of the friction ring element on the wheel web of a track wheel, i.e. when the friction ring element is mounted on the track wheel. Here, the parallel stop walls are arranged in such a way that a corresponding sliding block, which will be described further below, rests against the stop walls. In a preferred embodiment, the sliding block is provided with stop surfaces corresponding to the stop walls. For example, the stop surfaces are flat and parallel to the associated stop wall, preferably, the respective pair of stop surfaces as well as the associated pair of stop walls is plane-parallel. In one embodiment, a pair of stop walls forms a slot in which the sliding block is received. In an alternative embodiment, stop surfaces of the sliding block form a slot in which the connecting element is received.

By means of the stop walls of the connecting element, a force can be transferred in the direction of rotation of the track wheel from the connecting element to the corresponding sliding block, which in turn is fixedly connected to the wheel web of the track wheel. A relative movement, for example due to (different) thermal expansion, parallel to the radius (starting from the axis of rotation) of the track wheel still remains possible. The corresponding recess in the connecting element is already prefabricated in one embodiment, for example by milling, and introduced in another embodiment only after the mounting of the connecting element to the ring element.

In a preferred embodiment, in addition to ensuring that the connecting element does not contort in the course of the lifetime and possibly cants with the sliding block, the connecting element is secured relative to the friction ring by means of a positive-locking element, for example by means of a pin. For this purpose, for example, a bore is introduced parallel to the axis of rotation of the track wheel into the connecting element and into the friction ring, into which the positive-locking element, for example a pin, can be inserted. This device for the positive rotation lock of the connecting element can be introduced already before the mounting of the connecting element at the friction ring or can be introduced after assembly, for example by drilling.

In a preferred embodiment, all linking elements or at least some of the linking elements are configured as bolts. Such a bolt has a shaft and a head, wherein the shaft is configured for force-locking insertion into a corresponding opening in the friction ring. For a particularly cost-effective production the bolt is produced as a rotationally symmetric element, for example by means of the machining process turning. Here, the head forms the actual function of the linking element, for example by forming an axial stop against the wheel web. Particularly preferably such a bolt-like linking element is formed of strand material, particularly preferably formed of bar stock. Here, production costs and excess material are minimized.

The friction ring set further proposed here comprises a friction ring element as described above, as well as sliding blocks and connecting elements. The sliding blocks are arranged for torque-transmitting fixing of the friction ring element in the direction of rotation relative to the track wheel and preferably allow a radial relative movement between the track wheel or the wheel web and the friction ring element. Such radial relative movement occurs, for example, due to thermal expansion of the components. By means of the connecting elements the friction ring element can be mounted force-lockingly to the wheel web. If the friction ring set is connected to a wheel web of a track wheel, then the linking elements, at least those cooling elements setting a distance to the wheel web for cooling, are clamped between the wheel web and the friction ring by means of the connecting elements. The clamped linking elements are configured in such a way that a supported relative movement between the wheel web and the friction ring is made possible. As a result, the friction ring, at least with its friction surface, remains so flat that braking over an entire revolution of the friction ring is possible without interruption, and preferably with negligible deviation of frictional force.

In one embodiment, a number of sliding blocks corresponding to the number of connecting elements is provided and, in the case of an arrangement, that is to say assembly, arranged corresponding to each other at the wheel web of a track wheel, so that the sliding blocks abut on the stop walls of the respective associated connecting element with a clearance. The clearance between the sliding block and the stop walls here is to be made as low as possible, taking into account the manufacturing processes used and the costs. At the same time, however, a radial relative movement between the sliding block and the associated connecting element must be ensured, especially if the connecting element and/or the sliding block are heated as a result of a braking operation.

In a preferred embodiment, the sliding blocks are merely positively locked to the wheel web and are secured axially solely by means of the friction ring element and the wheel web. Particularly preferably, a friction ring set comprises two friction ring elements, which can be mounted in pairs and on both sides of a wheel web. In this embodiment, the friction ring elements of the friction ring set are preferably configured identical. Furthermore, the sliding block in this embodiment is preferably configured in such a way that it extends through the wheel web and is engaged with the stop walls at the ends with a connecting element each of the respective friction ring element, as described above. In the radial direction and in the direction of rotation, the sliding block is fixed in the recess of the wheel web.

The object of the present invention is also solved by a track wheel brake with a track wheel having a wheel hub and a wheel rim with a tread surface, wherein a wheel web extends between the wheel hub and the wheel rim, and wherein a friction ring set is arranged according to an embodiment as described above, which is fastened with the wheel web to the track wheel by means of the connecting elements.

For connecting the friction ring elements with the wheel web, connecting elements may be provided, and in case of the provision of two twin friction ring elements at one wheel web, the connecting elements can be provided for interlocking the two friction ring elements. For this purpose, the connecting element is preferably designed as a draw bolt with a locknut, so that a connection force defined via a torque can be applied. This ensures that a sufficiently high connection force is applied and at the same time a relative movement, in particular due to radial thermal expansion of one of the friction rings or the two friction rings, is possible in the context of loads and obligations of the friction surface according to the description above. This can be quickly and safely checked during quality assurance or maintenance by a torque wrench and a corresponding marking of the draw bolt.

### PREFERRED EMBODIMENT OF THE INVENTION

Further measures improving the invention are shown in more detail below together with the description of preferred embodiments of the invention with reference to the figures.

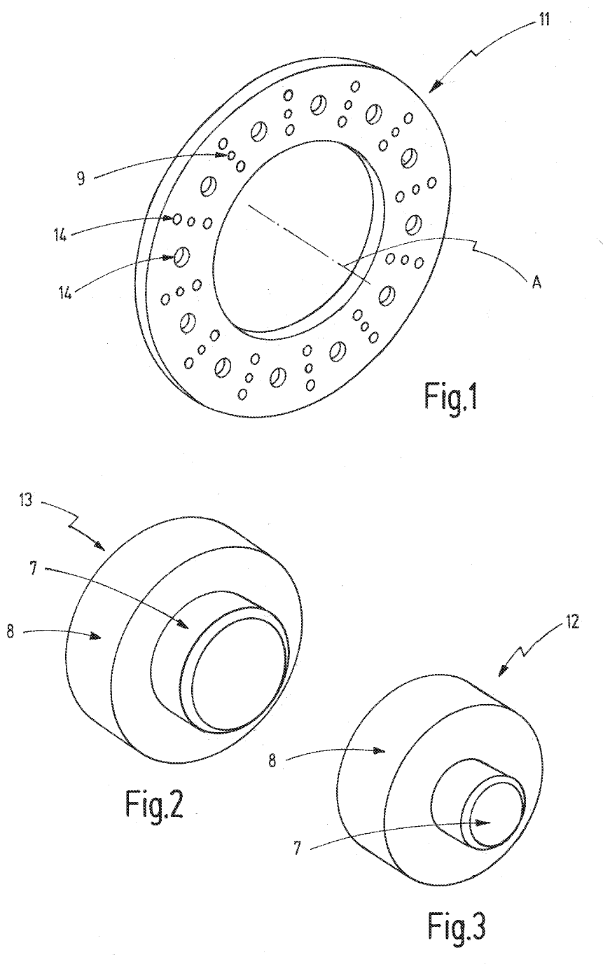

FIG. 1 shows a perspective view of a friction ring,

FIG. 2 shows a perspective view of a connecting element,

FIG. 3 shows a perspective view of a cooling element,

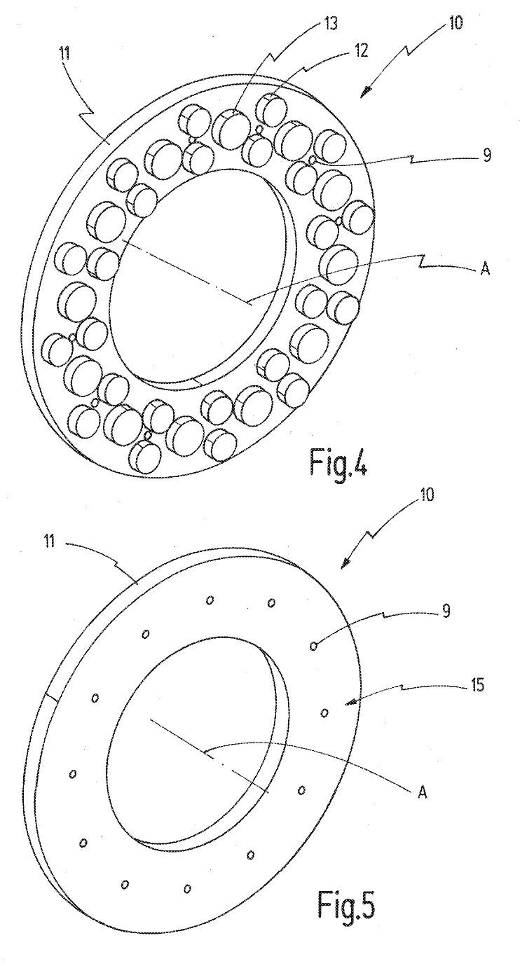

FIG. 4 is a perspective view of a friction ring element as a raw component on the connection element side,

FIG. 5 shows a perspective view of a friction ring element as a raw part on the frictional surface side,

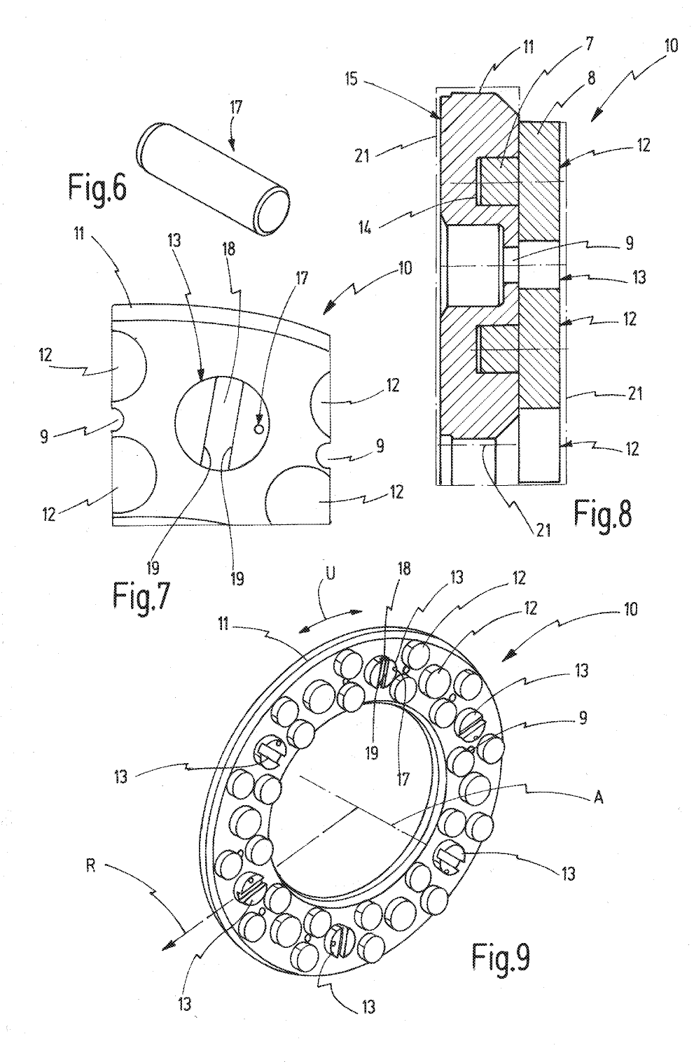

FIG. 6 shows a pin for a positive rotation lock of a connecting element,

FIG. 7 shows a plan view of a detailed section of a connecting element which is pinned, arranged on a friction ring,

FIG. 8 shows a sectional view of a machine finished friction ring element,

FIG. 9 shows a perspective view a finished friction ring element of the connection element side,

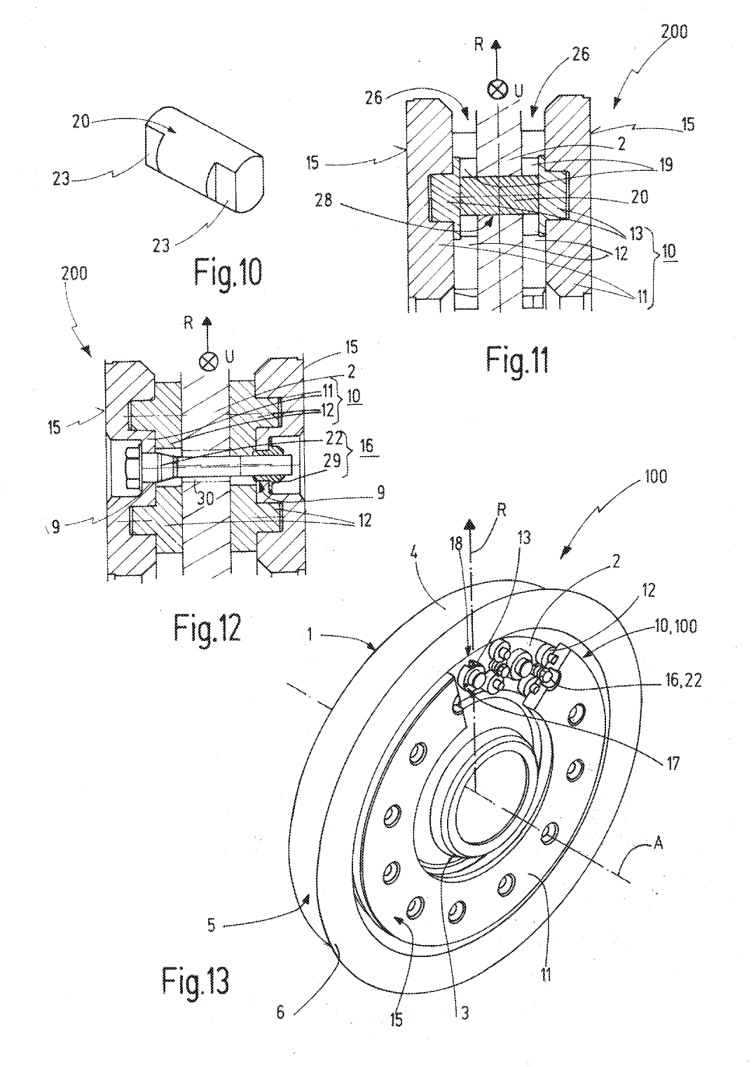

FIG. 10 shows a perspective view of a sliding block with stop surfaces,

FIG. 11 shows a sectional view of a friction ring set cut at a connecting element,

FIG. 12 shows a sectional view of a friction ring set cut at a connecting element,

FIG. 13 shows a perspective view of a track wheel brake.

FIG. 1 shows a friction ring 11 in a perspective view, in which case the side for the linking elements (see FIG. 2 and FIG. 3) can be seen, into which the openings 14 are introduced for the linking elements (not shown here). Furthermore, a plurality of fastening bores 9 are provided, by means of which the friction ring 11 can be connected to a wheel web (not shown here) of a track wheel. The friction ring 11 has an axis of rotation A. The openings 14 and the fastening bores 9 are arranged in this example rotationally symmetrical to the axis of rotation A.

In FIG. 2, by way of example, a connecting element 13 is shown, which can be pressed into the respective largest openings 14 as shown in FIG. 1 between each of the radial hole triples. Here, the connecting element 13 is configured bolt-like and has a shaft 7 for pressing into an opening 14 and a head 8 for the function of the connecting element 13. The shown connecting element 13 is still shown as a raw component here, in which the recess (see FIG. 7 and FIG. 9) is not yet introduced. Basically, this raw component can therefore also be used as a pure cooling element (see FIG. 9).

FIG. 3 shows a similarly constructed cooling element 12 with a shaft 7 and a head 8. The shaft 7 is in this case configured smaller than in the connecting element 13 according to FIG. 2 and can be pressed into the respectively smaller opening 14, as shown in FIG. 1

FIG. 4 shows a friction ring element 10 in a perspective view, with the side of the linking elements 12, 13 of the friction ring 11 being looked at here. Here, the linking elements 12 and 13 are pressed into the respective openings 14, which are now concealed (see FIG. 1). The fastening bores 9 remain free. The recess in the connecting element 13 is still not introduced (see FIG. 7 and FIG. 9).

FIG. 5 shows the same friction ring element 10 as in FIG. 4, with the friction surface 15 of the friction ring 11 being looked at here. From this representation, it is apparent that only the fastening bores 9 are through-holes and the openings 14 in this embodiment (see FIG. 1) are configured as blind holes.

In FIG. 6, a simple pin 17 is shown, which can be inserted for a positive rotation lock of a linking element (see FIG. 7).

FIG. 7 now shows a detailed view of a friction ring element 10 in plan view, wherein an exemplary connecting element 13 is shown. To the left and to the right of the connecting element 13, a plurality of cooling elements 12 and two fastening bores 9 are shown in a cut view. The connecting element 13 is pressed into a concealed opening 14 (see FIG. 1) and a recess 18, in this example after the aforementioned pressing, was introduced into the connecting element 13. In this example, also after the aforementioned pressing, a hole for a pin 17 is introduced to secure the connecting element 13 positively against rotation. The stop walls 19 of the recess 18 are aligned parallel to a radius R (see FIG. 9).

FIG. 8 shows a section through a friction ring element 10, which is machined after the aforementioned steps of FIGS. 1 to 7. The original shape, as still present in FIG. 5, is indicated by the dot-dashed finishing lines 21. The section shown here is guided through two cooling elements 12, so that their cut shaft 7 and head 8 as well as the openings 14, into which the cooling elements 12 are respectively pressed, can be seen. Furthermore, the fastening bore 9 can be seen, wherein here a sunken bore, here for an external hex, follows from the friction surface side. In the background, two linking elements 12 and 13 can also be seen, which have also been squared and/or ground, like the friction surface 15, so that all linking elements 12, 13 are configured planar in a common plane.

FIG. 9 shows a perspective view of a friction ring element 10 which is configured ready for mounting on a track wheel. Here, in particular, the connecting elements 13 with the recesses 18 and the corresponding positive locking elements 17 are to be observed. The stop walls 19 are configured parallel to the radius R to the axis of rotation A shown here by way of example. Here it can further be seen that not each of the large linking elements has to be configured as a connecting element 13, but can rather also be configured as a cooling element 12. The connecting elements 13 together with a sliding block (as shown for example in FIG. 10) now allow a relative radial movement to the track wheel, i.e. along the radius R. At the same time, however, they allow a force or torque transmission in the direction of rotation U relative to the axis of rotation A.

FIG. 10 shows a sliding block 20 with stop surfaces 23 to be seen here, which are plane-parallel with paired stop surfaces which are concealed here. The stop surfaces 23 are configured corresponding to the stop walls 19 of the recess 18 of a connecting element 13, as shown for example in FIG. 9.

FIG. 11 shows a section through a friction ring set 200 with a paired embodiment of friction ring elements 10 on the left and right of a wheel web 2. In this sectional view, a sliding block 20 and two corresponding connecting elements 13, the stop walls 19 of which can be seen, are shown. The sliding block 20 is hereby introduced through a recess 28 in the wheel web 2. The sliding block 20 extends through this recess 28, so that the stop surfaces 23 (see FIG. 10) are brought into force engagement with the stop walls 19 of the respective connecting elements 13. By means of the cooling elements 12, which can be seen here in the background, but also by means of the connecting elements 13, a ventilation gap 26 is generated respectively between the friction ring 11 and the wheel web 2. The friction surfaces 15, which are configured to act with a friction force by means of a brake pad (not shown), are each directed axially outward, i.e. away from the wheel web 2.

FIG. 12 shows a similar section through a friction ring set 200 as shown in FIG. 11, wherein in this case the section is guided through the fastening bores 9, so that here an exemplary connecting element 16 formed from a draw bolt 22 and a locknut 29 can be seen. Here it can further be seen that the cross-section of the draw bolt 22 is significantly smaller than the cross-section of the through hole 30 in the wheel web 2, so that via the draw bolt 22 no radial positioning and preferably also no positioning in the direction of rotation is made. Rather, it is indicated here by the centre line of the draw bolt 22 and the centre line of the through hole 30 non-overlapping with the former, that the draw bolt 22 is not or need not be centred to the through hole 30. In this section, further cooling elements 12 can be seen, which are pressed into the friction ring 11. Further, reference is made to the description of FIG. 11.

FIG. 13 shows a track wheel brake 100, which comprises a track wheel 1 and two friction ring elements 10 of a friction ring set 200. The friction ring elements 10 comprise a friction ring 11 and a plurality of linking elements 12, 13. Here only the first (on the flange side) friction ring element 10 can be seen. The second (on the tread surface side) friction ring element 10 is concealed in this illustration by the wheel web 2, but is held by the common connecting means 16 (see. FIG. 12). The track wheel 1 in this case has a wheel rim 4, which forms a tread surface 5 and a flange 6, by means of which the track wheel 1 is configured to roll on a rail. The wheel hub 3 in the centre of the track wheel 1 is configured for connecting the track wheel 1 to an axle or shaft (not shown). The axis of rotation A of the track wheel 1 is aligned concentrically with the friction ring elements 10. The wheel hub 3 is connected via a wheel web 2 with the wheel rim 4. In this wheel web 2, the connecting elements 16 and the sliding blocks 20 (concealed in this representation, see. FIG. 11) are introduced, and the linking elements 12, 13 are supported in the axial direction relative to the axis of rotation A. The cooling elements 12 form a spacer element between the friction ring 11 and the wheel web 2. The connecting elements 13 have a recess which is aligned parallel to the radius R. This alignment is secured by means of a positive locking element 17 with the friction ring 11 against relative distortion As a result, the friction ring element 10 can unhinderedly expand radially as a result of a thermal entry, i.e. it can perform a radial relative movement to the track wheel 1.

The figures and the associated description also show, in addition to exemplary embodiments, a preferred sequence of the steps of a manufacturing method.

With the track wheel brake or the friction ring elements shown here, a cost-effective production and a high degree of freedom in the selection of materials is achieved.

### LIST OF REFERENCE NUMBERS

100 track wheel brake
200 friction ring set
1 track wheel
2 wheel web
3 wheel hub
4 wheel rim
5 tread surface
6 flange
7 shaft
8 head
9 fastening bore in the friction ring
10 friction ring element
11 friction ring
12 linking element, cooling element
13 linking element, connecting element
14 opening in the friction ring
15 friction surface of the friction ring element
16 connecting element
17 positive-locking element or pin
18 recess in the connecting element
19 stop walls of the recess
20 sliding block
21 finishing lines of the friction ring element
22 draw bolt
23 stop surfaces of the sliding block
26 ventilation gap
28 recess in the wheel web
29 locknut
30 through hole in the wheel web
A rotation axis
R radius
U direction of rotation

1. A friction ring element (10) for a friction ring set (200) for arranging on the wheel web (2) of a track wheel (1) for a rail vehicle in order to form a track wheel brake (100), wherein the friction ring element (10) has a friction ring (11) and several linking elements (12, 13) configured as separate components and arranged on the friction ring (11),
characterized in that
at least some of the linking elements (12, 13) are force-lockingly connected to the friction ring (11).

2. A friction ring element (10) according to claim 1, wherein the linking elements (12, 13) force-lockingly connected to the friction ring (11) are each pressed into a corresponding opening (14) in the friction ring (11).

3. A friction ring element (10) according to claim 1, wherein the friction ring (11) is cut out of a flat metal material, wherein the friction ring (11) is preferably cut out of flat steel material or flat aluminium material.

4. (canceled)

5. A friction ring element (10) according to claim 1, wherein the linking elements (12, 13) and the friction ring (11) are formed of different metallic materials, in particular forming a material pairing unsuitable for a favourable welding process.

6. A friction ring element (10) according to claim 1, wherein the linking elements (12) form cooling elements, by means of which in the arrangement of the friction ring element (10) to the wheel web (2) of a track wheel (1), a cooling air flow can be formed between the friction ring (11) and the wheel web (2).

7. A friction ring element (10) according to claim 1, wherein the linking elements (13) form connecting elements, by means of which in the arrangement of the friction ring element (10) to the wheel web (2) of a track wheel (1), the friction ring (11) is supported on the wheel web (2) of the track wheel (2) in the direction of rotation (U) with reference to the axis of rotation (A) of the track wheel (1), wherein the connection elements (13) preferably have a recess (18) with two stop walls (19) parallel to each other, and the stop walls (19) in the arrangement on the wheel web (2) on a track wheel (1) are aligned parallel to a radius (R) from the rotational axis (A) of the track wheel (1), wherein further preferably the connecting element (13) is secured against rotation relative to the friction ring (11) by means of a positive-locking element (17), particularly preferably a pin.

8. (canceled)

9. (canceled)

10. A friction ring element (10) according to claim 1, wherein the linking elements (12, 13) are configured as a bolt with a shaft (7) and with a head (8), wherein the shaft (7) is force-lockingly connected to the friction ring (11) and the head (8) in the arrangement on the wheel web (2) of a track wheel (1) forms an axial stop against the wheel web (2) with respect to the axis of rotation (A).

11. A friction ring element (10) according to claim 1, wherein the linking elements (12, 13) are formed of strand material.

12. A friction ring element (10) according to claim 1, wherein the linking elements (12, 13) are formed of steel or aluminium.

13. A friction ring element (10) according to claim 1, wherein the friction ring (11) and/or the linking elements (12,13) are cut out from or cut off from a solid material by means of a laser beam cutting process, a water jet cutting process or a thermal separation process.

14. A friction ring set (200) for arranging on the wheel web (2) of a track wheel (1) for a rail vehicle in order to form a track wheel brake (100), comprising at least the following components:
at least one friction ring element (10) according to claim 1;
sliding blocks (20) for torque-transmitting fixing of the friction ring element (10) in the arrangement on the wheel web (2) of a track wheel (1) in the direction of rotation (U) with respect to the axis of rotation (A) of the track wheel (1);
connecting elements (16) for force-locking connection of the friction ring element (10) to the wheel web (2) of a track wheel (1),
wherein in the arrangement on the wheel web (2) of a track wheel (1) at least some of the linking elements (12, 13) are clamped between the friction ring (11) and the wheel web (2) by means of the connecting elements (16).

15. A friction ring set (200) according to claim 14, wherein a plurality of connecting elements (13) are provided according to claim 7, and wherein the sliding blocks (20) form a number corresponding to the connecting elements (13) and in the arrangement on the wheel web (2) of a track wheel (1) are arranged correspondingly, and the sliding blocks (20) abut with a clearance on the stop walls (19) of the respectively associated connecting element (13) and are movable radially relative to each other with reference to the axis of rotation (A) of the track wheel (1) and fix the friction ring element (10) in the direction of rotation (U) in a torque transmitting manner.

16. A friction ring set (200) according to claim 15, wherein the sliding blocks (20) can be arranged in a bolt-like manner in a recess (28) each in the wheel web (2).

17. A friction ring set (200) according to claim 14, wherein the friction ring set (200) comprises two friction ring elements (10) for a pairing arrangement on both sides of the wheel web (2) of a track wheel (1).

18. A friction ring set (200) according to claim 17, wherein at least one of the sliding blocks (20) is configured for torque-transmitting fixing in the direction of rotation (U) of both friction ring elements (10) and in the arrangement on the wheel web (2) of a track wheel (1) extends through a recess (28).

19. A friction ring set (200) according to claim 18, wherein the at least one sliding block (20) in the arrangement on the wheel web (2) of a track wheel (1) is axial with reference to the axis of rotation (A) of the track wheel (1) and/or is secured against rotation around its axial extent by means of the associated connecting elements (13).

20. A track wheel brake (100) with a track wheel (1), having a wheel hub (3) and a wheel rim (4) with a tread surface (5), wherein a wheel web (2) extends between the wheel hub (3) and the wheel rim (4), and wherein a friction ring set (200) according to claim 14 is arranged, which is fastened on the wheel web (2) on the track wheel (1) by means of the connecting elements (16).

21. A track wheel brake (100) according to claim 20, wherein at least one of the connecting elements (16) comprises a draw bolt (22) and a locknut (29).

22. A track wheel brake (100) according to claim 21, with a friction ring set (200) according to claim 17, wherein the at least one connecting element (16) fixes both friction ring elements (10) to the wheel web (2).

23. A track wheel brake (100) according to claim 21, wherein the at least one connecting element (16) extends through a through hole (30) in the wheel web (2), and the through hole (30) has a larger cross-section than the cross-section of the section of the connecting element (16) arranged in the region of the through hole (30).
